(19) United States
(12) Patent Application Publication
(10) Pub. No.: US 2024/0308410 A1
(43) Pub. Date: Sep. 19, 2024

(54) DUAL RING RECESSED PAD EYE

(71) Applicant: Suncor Stainless Inc., Plymouth, MA (US)

(72) Inventors: Patrick Striebel, Duxbury, MA (US); David Dion, Marion, MA (US); James Storrer, Middleboro, MA (US)

(73) Assignee: Suncor Stainless Inc., Plymouth, MA (US)

(21) Appl. No.: 18/604,999

(22) Filed: Mar. 14, 2024

Related U.S. Application Data
(60) Provisional application No. 63/451,944, filed on Mar. 14, 2023.

(51) Int. Cl. B60P 7/08

(52) U.S. Cl. CPC B60P 7/0807

(57) ABSTRACT

A pad eye assembly device includes one or more rings disposed within a recess of a base. The one or more shafts are disposed within the recess. The one or more shafts respectively secure each of the one or more rings to the recess at first and a second proximal ends. The one or more rings rotate axially about the recess via the one or more shafts.

### CROSS-REFERENCE TO RELATED APPLICATION

The present application claims the benefit of provisional application No. 63/451,944, filed Mar. 14, 2023.

### FIELD OF TECHNOLOGY

The present disclosure is in the field of pad eyes, and more particular in the field of a pad eye assembly in recessed pan fittings.

### BACKGROUND

Pad eyes are one of the most universally used structural items used as a tie down in commercial transportation such as trailers and box trucks, maritime cargo hold or deck storage, and industrial applications. They primarily secure cargo to the deck of a transport vehicle typically involving multiple lashing points. The cargo is typically strapped down to the pad eye using webbing with ratchet, rope, or chain with a specific type of hook.

Some types of similar tie downs with two rings may be currently available as shown in U.S. Pat. No. D520,343 and U.S. Pat. No. 8,075,232, for example. U.S. Patent No. D520.343 illustrates a combination of two single pad eye assemblies in an non-economical configuration. U.S. Pat. No. 8,075,232 describes an attachment of two rings to rotational bar in a complex and costly configuration. Some transport regulations such as European Standard DIN EN 12640 do not permit ring swiveling devices such as shown in U.S. Pat. No. 8,075,232.

### SUMMARY

According to one aspect, a pad eye assembly is provided. The assembly includes one or more rings disposed within a recess of a base. The one or more shafts are disposed within the recess. The one or more shafts respectively secure each of the one or more rings to the recess at first and a second proximal ends. The one or more rings rotate axially about the recess via the one or more shafts.

In some implementations of the assembly, the recess includes one or more holes for fastening the one or more shafts to the recess. Fastening the one or more shafts to the recess may include one or more pins. Fastening the one or more shafts to the recess may include one or more bolts. Fastening the one or more shafts to the recess may include one or more spring mechanisms.

In some implementations of the assembly, the one or more rings include the one or more shafts disposed within the recess. In some implementations of the assembly, the one or more shafts further comprising an interior plate fastened to the recess. In some implementations of the assembly, the one or more shafts are welded to the recess.

In some implementations of the assembly, the one or more holes for fastening the one or more shafts to the recess include one or more side walls within the recess. In some implementations of the assembly, the base further comprises a backing plate, wherein the backing plate includes one or more holes for fastening the base to a surface.

In some implementations of the assembly, one or more of the one or more shafts support one or more retaining forces applied against first and/or second distal ends at one or more of the one or more rings. The one or more of the one or more rings may be positioned at one or more non-zero angles when one or more retaining forces is applied. The one or more of the one or more rings may support two half load capacities when two or more retaining forces are applied to the one or more of the one or more rings. In some implementations of the assembly, each of the one or more rings may support a one full load capacity when one retaining force is applied to each of the one or more of the one or more rings.

In some implementations of the assembly, the one or more rings disposed in the recess are flush with the one or more non-recessed portions when positioned at a zero angle. In some implementations of the assembly, the base is a pan. In some implementations of the assembly, the recess further includes one or more troughs disposed beneath each of the one or more rings. In some implementations of the assembly, the one or more rings are the same shape to support one or more retaining forces. In some implementations of the assembly, the one or more rings are different shapes to support one or more retaining forces.

According to another aspect, pad eye assembly includes one or more rings disposed within a recess of a base. The base further includes a backing plate, and the backing plate includes one or more holes for fastening the base to a surface. The assembly includes one or more shafts disposed within the recess, and the one or more shafts respectively secure each of the one or more rings to the recess at first and a second proximal ends. The recess includes one or more holes for fastening the one or more shafts to the recess. The one or more rings rotate axially about the recess via the one or more shafts to support one or more retaining forces. In the assembly, one or more of the one or more shafts support the one or more retaining forces applied against first and/or second distal ends at one or more of the one or more rings when the one or more of the one or more rings is positioned at one or more non-zero angles when one or more retaining forces is applied.

### BRIEF DESCRIPTION OF THE DRAWINGS

For a better understanding of the present invention, together with other and further objects thereof, reference is made to the accompanying drawing and detailed description, wherein:

FIG. 1A is an exemplary exploded pictorial view drawing, illustrating a double ring pad eye assembly, according to an aspect of the present disclosure;

FIG. 1B is an exemplary pictorial view drawing of a finger access trough formed in a recessed pan fitting, according to an aspect of the present disclosure;

FIG. 1C is an exemplary pictorial view drawing, showing a double ring pad eye assembly, according to an aspect of the present disclosure;

FIG. 1D is an exemplary pictorial cross-sectional view drawing, showing spring orientation details of a double ring pad eye assembly, according to an aspect of the present disclosure;

FIG. 2 is an exemplary pictorial view drawing of a backing plate, according to an aspect of the present disclosure;

FIG. 3 is an exemplary pictorial view drawing of a bolted implementation of the disclosed pad-eye assembly, according to an aspect of the present disclosure;

FIG. 4 is an exemplary pictorial view drawing of a welded implementation of the disclosed pad-eye assembly, according to an aspect of the present disclosure;

FIG. 5 is an exemplary pictorial view drawing, showing load rating for a single pad eye with two lashings, according to an aspect of the present disclosure;

FIG. 6 is an exemplary pictorial view drawing, showing a full capacity load permitted on each ring of a dual ring pad-eye apparatus, according to an aspect of the present disclosure; and

FIG. 7 is an exemplary image, illustrating two load restraint connections used for opposing load restraint directions, according to an aspect of the present disclosure.

Like reference numerals in different Figures indicate like elements.

### DETAILED DESCRIPTION

Aspects of the present disclosure include one or more pad eye assemblies. The present disclosure provides one or more similar and independent load rings in a single assembly unit. This can provide one or more tie-down points within a single assembly fitting. In implementations, the disclosed assemblies can be mounted to a load bearing surface and/or frame to transfer cargo loads to a transport vehicle cargo bed. Manufactures continually develop new assemblies that are increasingly more functional, stronger, more economical and easier to install. There is a heretofore unmet need for a single assembly with one or more non-swiveling, but hinging, rings to achieve this objective.

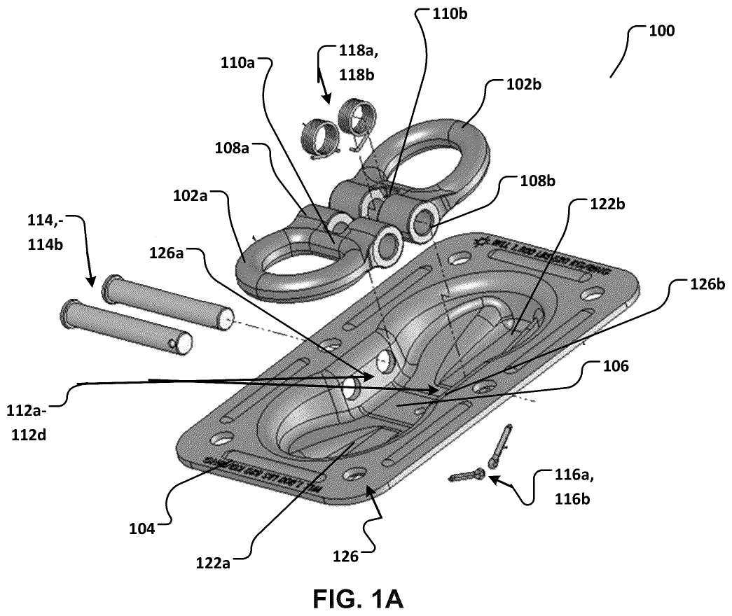

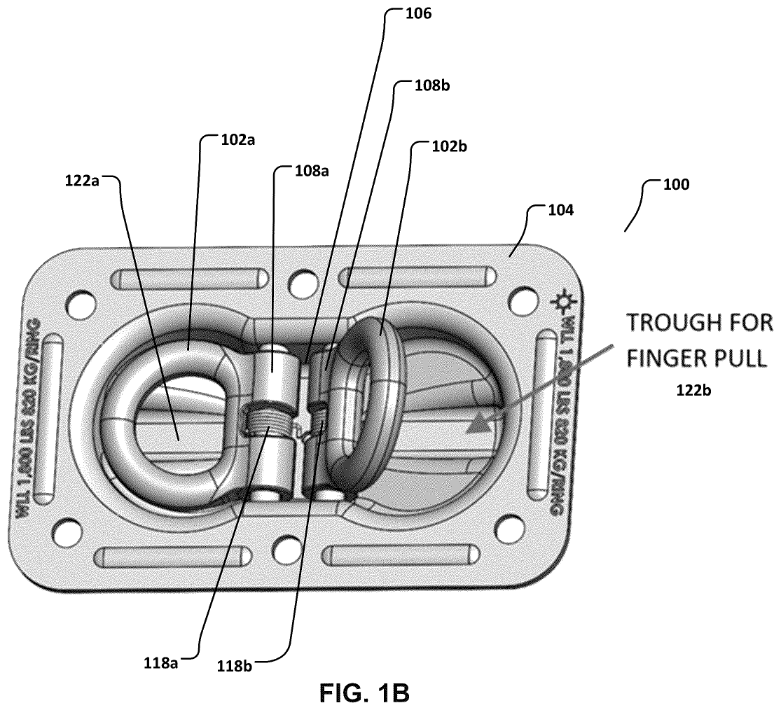

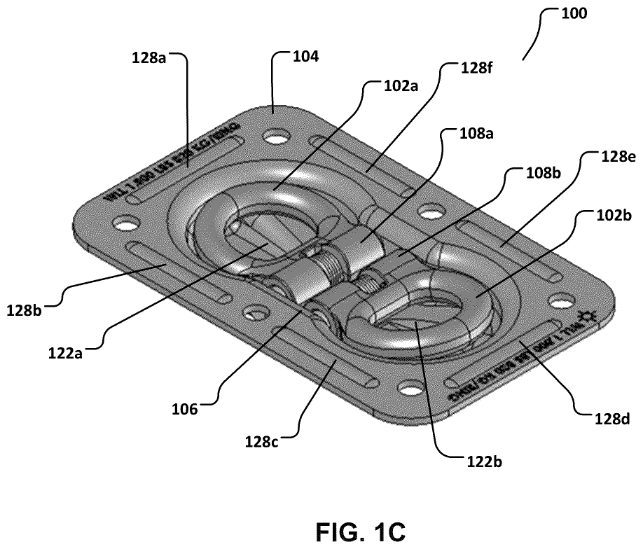

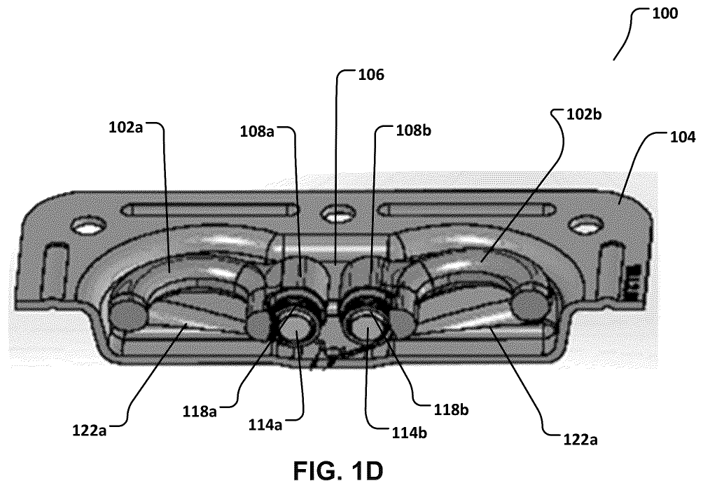

FIGS. 1A-1D include exemplary exploded pictorial view drawings, illustrating double ring pad eye assembly 100, according to an aspect of the present disclosure. In some implementations, the assemblies of this disclosure can include single pad eye assemblies, with one ring. Pad eye assembly 100 can include at least one ring; in FIGS. 1A-1D, two or more rings 102a and 102b disposed within a recess 106 of a base 104. Base 104 can include a pan fitting. As shown in FIGS. 1A-1D, two or more rings 102a and 102b may include opposing rings integrally mounted in a single recessed pan fitting, such as recess 106 of base 104. In implementations, two or more rings 102a and 102b may include hinging rings. Various shaped rings other than the “D” rings shown can be used, such as rectangular and triangular, to suit requirements for different restraining devices and/or hooks.

FIG. 1C is an exemplary pictorial view drawing, showing double ring pad eye assembly 100 when assembled and withdrawn to remain flush with base 104, as two or more rings 102a and 102b are disposed within recess 106. In examples, base 104 may be utilized within a recessed pan type pocket to fit flush on a cargo deck, underscoring the value of two or more rings 102a and 102b to be disposed flushly within recess 106 of base 104.

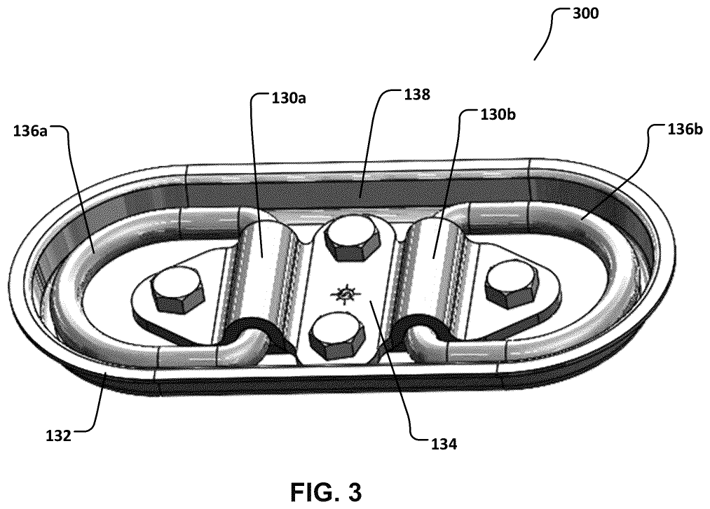

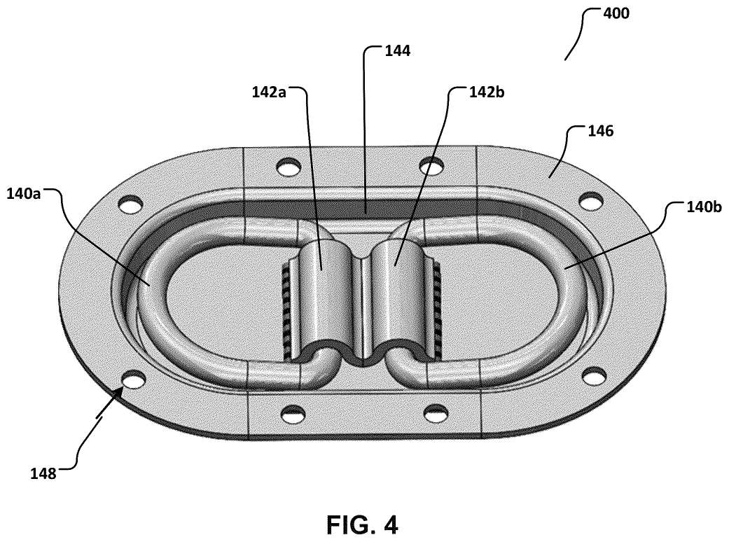

As shown in FIGS. 1A-1D, two or more rings 102a and 102b may be disposed within recess 106 via two or more shafts 108a and 108b. Two or more shafts 108a and 108b and two or more rings 102a and 102b may respectively comprise a single component, as shown in FIGS. 1A-1D, 5, and 6, or represent distinct components, as shown in FIGS. 3 and 4. In implementations, the two or more shafts 108a and 108b respectively secure each of the two or more rings 102a and 102b to the recess 106 at first and a second proximal ends 110a and 110b. The eyes of two or more shafts 108a and 108b at first and a second proximal ends 110a and 110b may thereby attach to base 104 as the two or more shafts 108a and 108b may be retained in recess 106 of base 104.

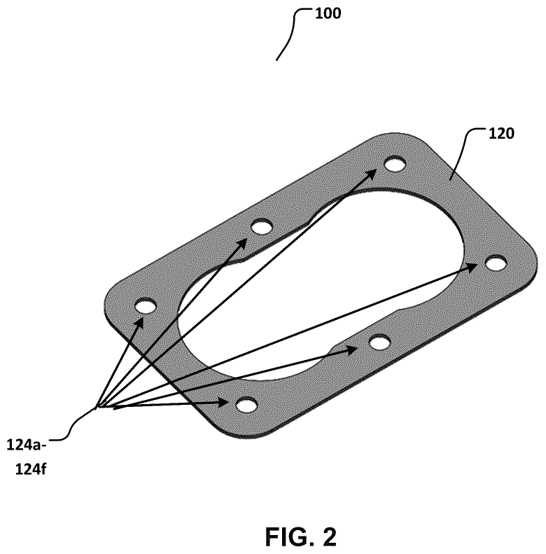

As illustrated in FIGS. 1A-1D, recess 106 of base 104 can include side walls 126a and 126, which can respectively include two or more holes 112a and 112b and/or 112c and 112d (not shown) for fastening the two or more shafts 108a and 108b to the recess 106. In implementations of assembly 100, fastening the two or more shafts 108a and 108b to the recess 106 can include two or more bolts 114a and 114b. In implementations, 114a and 114b can also correspond to clevis pins or press fit roll/spring pins. In implementations of assembly 100, fastening the two or more shafts 108a and 108b to the recess 106 can also include two or more pins 116a and 116b. In implementations, 116a and 116b can include cotter pins. Base 104 can further include one or more holes 126 for fastening base 104 to plate 120 of FIG. 2 and/or an additional surface via screws, nails, or like components. The perimeter has reinforcing ribs 128a-128f, as shown in FIGS. 1A-1D, which can stiffen the edges between the mounting holes 126. Mounting holes 126 in the base 104 can be round, square, and/or otherwise shaped to accommodate these securing components.

As shown in FIGS. 1A-1D, and most particularly in FIG. 1D, two or more springs 118a and 118b can be attached in tandem with each of the two or more shafts 108a and 108b to secure two or more rings 102a and 102b around, for example, two or more bolts 114a and 114b. This can enable two or more rings 102a and 102b to be secured in a flush, downward position when not in use. In examples, this can also serve as an anti-rattle provision.

Also shown in FIGS. 1A-1D, two or more rings 102a and 102b may rotate axially about the recess 106 via the two or more shafts 108a and 108b. In implementations, each ring 102a and/or 102b can rotate independently about their respective shaft 108a and/or 108b at first and/or second proximal ends 110a and 110b to permit a range of pull angles. FIG. 1B illustrates finger access troughs 122a and 122b formed in recess 106, which can be utilized in some implementations to allow a user to access ring 102a and/or 102b, respectively, in order to adjust the pull angle of ring 102a and/or 102b by rotating shaft 108a and/or 108b at first and/or second proximal ends 110a and 110b.

FIG. 2 is an exemplary pictorial view drawing of a backing plate 120 for assembly 100, as introduced in FIGS. 1A-1D. In implementations, backing plate 120 can be inserted underneath base 104, as introduced in FIGS. 1A-1D, via one or more holes 124a-124f. One or more holes 124a-124f can be positioned in coordination with one or more holes 126 to fasten base 104 to a surface (not shown). In examples, when backing plate 120 is installed underneath base 104, the mounting strength to a surface, such as a vehicle frame or bed, is increased. As previously discussed, typical mounting utilizes nails, screws, through bolts with nuts and/or washers to secure base 104 to backing plate 120 and/or a surface. The assembly 100 can thereby be mounted to, for example, a cargo deck, with multiple fasteners around the perimeter of the base 104, as shown in FIGS. 1A-1D.

FIG. 3 is an exemplary pictorial view drawing of a bolted implementation 300 of the disclosed pad-eye assembly 100, according to an aspect of the present disclosure. These two or more rings 136a and 136b may rotate similarly to those introduced in FIGS. 1A-1D to receive retaining forces at various angles. Implementation 300 is similar to implementation 100, except for several key differences. In assembly 300, the two or more shafts 130a and 130b, which secure two or more rings 136a and 136b to recess 138 of base 132, may be distinct components. Although not shown, in implementations, a trough similar to that previously introduced may or may not be present. Additionally, base 132 may not include one or more holes 112a-112d for inserting bolts 114a and 114b into base 132 for securing two or more rings 102a and 102b to recess 106. Instead, two or more rings 136a and 136b, by way of shafts 130a and 130b, are bolted to recess 138 via interior plate 134. As shown in FIG. 3, interior plate 134 may include two or more shafts 130a and 130b. These bolts may alternatively include screws, nails, or like components, and may be secured to a backing plate underneath assembly 300, in a similar fashion to backing plate 120. In implementations, these one or more bolts of interior plate 134 may also secure and/or mount the pan 132 and ring retaining member 134 to a load bearing surface and/or frame beneath assembly 300.

FIG. 4 is an exemplary pictorial view drawing of a welded implementation 400 of the disclosed pad-eye assembly 100, according to an aspect of the present disclosure. These two or more rings 140a and 140b may rotate similarly to those introduced in FIGS. 1A-1D and 3 to receive retaining forces at various angles. Implementation 400 is similar to implementation 100, except for a few key differences. In assembly 400, the two or more shafts 142a and 142b, which secure two or more rings 140a and 140b to recess 144 of base 146, may be distinct components. Although not shown, in implementations, a trough similar to that previously introduced may or may not be present. Again, base 146 may not include one or more holes 112a-112d for inserting bolts 114a and 114b into base 146 for securing two or more rings 102a and 102b to recess 106. Instead, two or more rings 140a and 140b, by way of shafts 142a and 142b, are welded to recess 144. As shown in FIG. 4, base 146 may further include one or more holes 148, similar to one or more holes 126 in FIGS. 1A-1D, for securing base 146 to a backing plate and/or surface, such as to a load bearing surface and/or frame beneath assembly 400. This may be achieved via screws, nails, or like components, and may be secured in a similar fashion to backing plate 120.

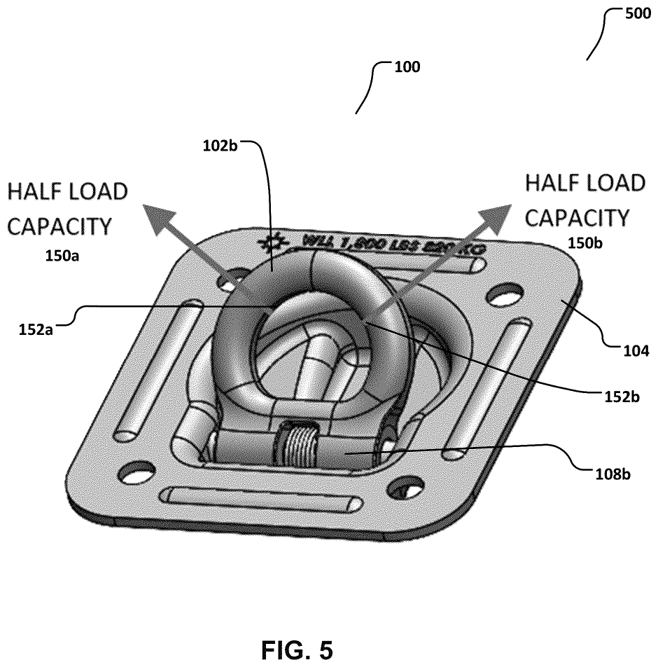

FIG. 5 is an exemplary pictorial view drawing 500 of assembly 100 as it receives retaining forces 150a and 150b. While assembly 100 is depicted, assemblies 300 and 400 may behave similarly in implementations. As shown in FIG. 5, assembly 100 can withstand two or more retaining forces/lashings 150a and 150b to one 108b or more of the two or more shafts 108a and 108b and/or one 102b or more of the two or more rings 102a and 102b. In implementations, the combination of 102b and 108b can be referred to as a single pad eye, as part of a set, within assembly 100. In FIG. 5, these retaining forces/lashings 150a and 150b include an individual load rating of half load capacity when applied against first and/or second distal ends 152a and 152b of the one 102b or more of the two or more rings 102a and 102b. In implementations, 102b or more of the two or more rings 102a and 102b is positioned at one or more non-zero angles when one or more retaining forces 150a and 150b are applied. For example, if a single pad eye 102b and 108b is used for two hook attachments at 152a and 152b, the lashing capacity 150a and 150b is half the total, full capacity, as illustrated in FIG. 5. This may typically be suited for mid-point tie down application, whereby two load restraint connections require opposing load restraints directions, as shown in FIG. 5.

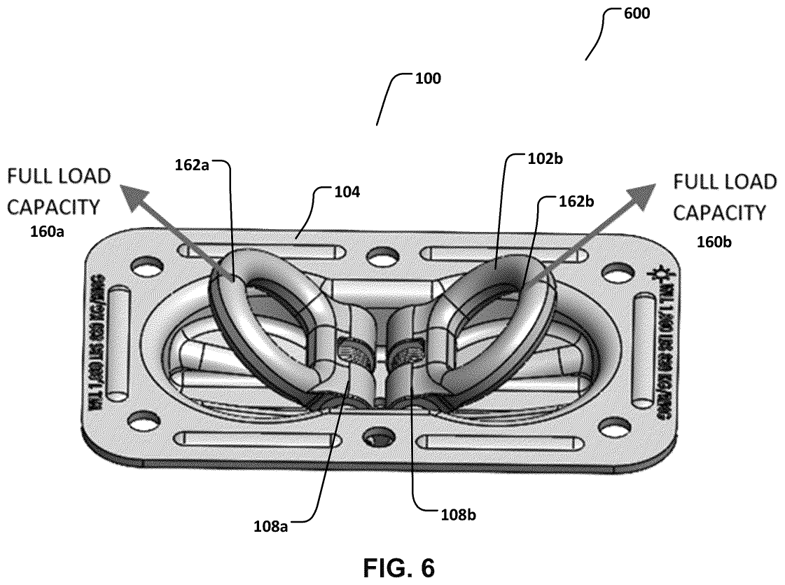

FIG. 6 is an exemplary pictorial view drawing 600, showing full capacity loads 160a and 160b as permitted on each ring 102a and 102b, respectively of dual ring pad-eye apparatus 100, according to an aspect of the present disclosure. Again, while assembly 100 is depicted, assemblies 300 and 400 may behave similarly in implementations. As shown in FIG. 6, assembly 100 can withstand two or more opposing retaining forces/lashings 160a and 160b to two or more shafts 108a and 108b and/or two or more rings 102a and 102b, respectively. In FIG. 6, these retaining forces/lashings 160a and 160b include an individual load rating of full load capacity when applied against first and/or second distal ends 162a and 162b of 102a and 102b, respectively. In implementations, 102a and/or 102b of the two or more rings are positioned at one or more non-zero angles when one or more retaining forces 160a and 160b are applied. For example, if both pad eyes 102a, 102b, 108a, and 108b are used for two hook attachments at 162a and 162b, the lashing capacity 160a and 160b can each support total, full capacities, as illustrated in FIG. 6. This may typically be suited for tie down applications in opposing directions and/or that of a single device.

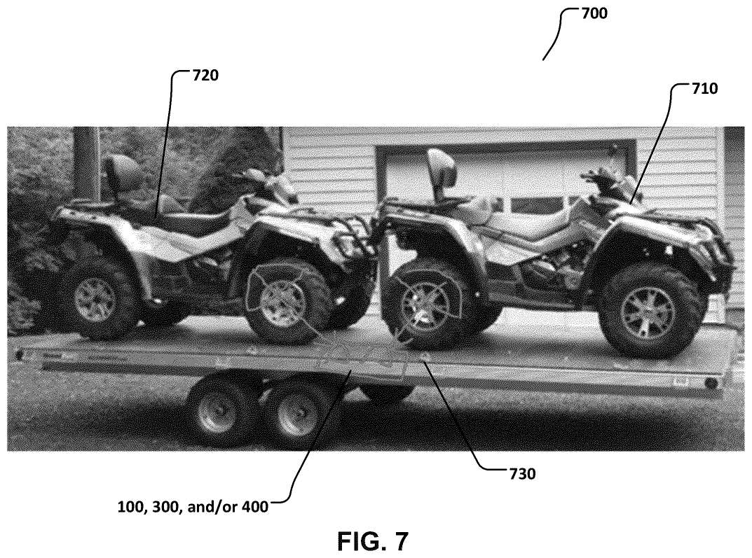

FIG. 7 includes an exemplary image 700, illustrating two load restraint connections used for opposing load restraint directions, according to an aspect of the present disclosure. This may be achieved in the manner presented in FIGS. 5 and/or 6, and include assemblies such as those introduced in 100, 300, and/or 400. In this way, vehicles 710 and/or 720 may be fastened via, for example, respective hooks to assembly 100, 300, or 400, as secured to surface 730. Here, each vehicle 710 and 720 are secured to surface 730 as shown in FIG. 6, allowing for full load capacity in each direction. In implementations, an assembly can be positioned to support, for example, four vehicles, each of which can be secured at half capacity to a surface, such as surface 730, in the manner as introduced in FIG. 5.

The fittings disclosed herein are fabricated from stainless steel. The disclosed assemblies and mounting plates are either 316L or 304L low carbon grade for welding. The backing plate is either 316 or 304 stainless steel. Although the disclosed implementations, are made from stainless steel, it should be understood that various alternative implementations may be made from other metals, such as brass, bronze, aluminum and the like.

Elements of different implementations described may be combined to form other implementations not specifically set forth previously. Elements may be left out of the systems described previously without adversely affecting their operation or the operation of the system in general. Furthermore, various separate elements may be combined into one or more individual elements to perform the functions described in this specification.

Other implementations not specifically described in this specification are also within the scope of the following claims.

What is claimed is:

1. A pad eye assembly comprising,
one or more rings disposed within a recess of a base; and
one or more shafts disposed within the recess, wherein the one or more shafts respectively secure each of the one or more rings to the recess at first and a second proximal ends,
wherein the one or more rings rotate axially about the recess via the one or more shafts.

2. The pad eye assembly of claim 1, wherein the recess includes one or more holes for fastening the one or more shafts to the recess.

3. The pad eye assembly of claim 2, wherein fastening the one or more shafts to the recess includes one or more pins.

4. The pad eye assembly of claim 2, wherein fastening the one or more shafts to the recess includes one or more bolts.

5. The pad eye assembly of claim 2, wherein fastening the one or more shafts to the recess includes one or more spring mechanisms.

6. The pad eye assembly of claim 1, wherein the one or more rings include the one or more shafts disposed within the recess.

7. The pad eye assembly of claim 1, the one or more shafts further comprising an interior plate fastened to the recess.

8. The pad eye assembly of claim 1, wherein the one or more shafts are welded to the recess.

9. The pad eye assembly of claim 2, wherein the one or more holes for fastening the two or more shafts to the recess include one or more side walls within the recess.

10. The pad eye assembly of claim 2, the base further comprising a backing plate, wherein the backing plate includes one or more holes for fastening the base to a surface.

11. The pad eye assembly of claim 1, wherein one or more of the one or more shafts support one or more retaining forces applied against first and/or second distal ends at one or more of the one or more rings.

12. The pad eye assembly of claim 11, wherein the one or more of the one or more rings is positioned at one or more non-zero angles when one or more retaining forces is applied.

13. The pad eye assembly of claim 12, wherein the one or more of the one or more rings supports two half load capacities when two or more retaining forces are applied to the one or more of the one or more rings.

14. The pad eye assembly of claim 12, wherein each of the one or more rings supports a one full load capacity when one retaining force is applied to each of the one or more of the one or more rings.

15. The pad eye assembly of claim 10, wherein the one or more rings disposed in the recess are flush with the one or more non-recessed portions when positioned at a zero angle.

16. The pad eye assembly of claim 1, wherein the base is a pan.

17. The pad eye assembly of claim 1, the recess further comprising one or more troughs disposed beneath each of the one or more rings.

18. The pad eye assembly of claim 1, wherein the one or more rings are the same shape to support one or more retaining forces.

19. The pad eye assembly of claim 1, wherein the one or more rings are different shapes to support one or more retaining forces.

20. A pad eye assembly comprising,
one or more rings disposed within a recess of a base, the base further comprising:
a backing plate, wherein the backing plate includes one or more holes for fastening the base to a surface; and
one or more shafts disposed within the recess, wherein the one or more shafts respectively secure each of the one or more rings to the recess at first and a second proximal ends, wherein the recess includes one or more holes for fastening the one or more shafts to the recess,
wherein the one or more rings rotate axially about the recess via the one or more shafts to support one or more retaining forces,
wherein one or more of the one or more shafts support the one or more retaining forces applied against first and/or second distal ends at one or more of the one or more rings when the one or more of the one or more rings is positioned at one or more non-zero angles when one or more retaining forces is applied.
